(19) United States
(12) Patent Application Publication
(10) Pub. No.: US 2011/0304075 A1
(43) Pub. Date: Dec. 15, 2011

(54) Breakable Mechanical Connection Between Injection Molding Valve Pin Plate and Valve Pins

(75) Inventors: Bruce Catoen, Georgetown (CA); Murray Feick, Kitchener (CA); Valery Ten, Burlington (CA)

(73) Assignee: MOLD-MASTERS (2007) LIMITED, Georgetown, ON (CA)

(21) Appl. No.: 13/057,692

(22) PCT Filed: Jul. 30, 2009
(86) PCT No.: PCT/CA2009/001067

§ 371 Date: Feb. 4, 2011

Related U.S. Application Data
(60) Provisional application No. 61/085,901, filed on Aug. 4, 2008.

(51) Int. Cl. B29C 45/38

(52) U.S. Cl. 264/328.1; 425/562

(57) ABSTRACT

Breakable mechanical connections connect valve pins to an actuated valve pin plate of an injection molding apparatus. The valve pin plate can move the valve pins between opened positions and closed positions of associated mold gates. Each breakable mechanical connection can be independently or singularly destroyed or broken to free a respective valve pin from the valve pin plate.

### FIELD OF THE INVENTION

The invention relates to injection molding, and more particularly, an injecting molding apparatus in which a plurality of valve pins are actuated by a valve pin plate.

### BACKGROUND OF THE INVENTION

Injection molding apparatuses, such as hot halves and hot runners, commonly use valve pins to control flow of molding material.

When a cavity, valve pin, heater, mold gate, or other related component wears or fails, the molded product may have defects and the injection molding apparatus may have to be shut down for maintenance or repair. Such downtime decreases production time, which is nearly always sought to be maximized.

### BRIEF SUMMARY OF THE INVENTION

According to one aspect of the present invention, breakable or destroyable mechanical connections connect valve pins to an actuated valve pin plate of an injection molding apparatus. The valve pin plate can move the valve pins between open and closed positions with reference to the associated mold gates. Each breakable or destroyable mechanical connection can be broken or destroyed to free a valve pin from movement with the valve pin plate.

### BRIEF DESCRIPTION OF THE FIGURES

Embodiments of the present invention will now be described more fully with reference to the accompanying drawings in which:

FIG. 1 is a cross-sectional view of an injection molding apparatus according to an embodiment of the present invention;

FIG. 2A is an enlarged view of the valve pin coupling of FIG. 1;

FIG. 2B shows the screw of FIG. 2A broken under a breaking load;

FIG. 3 is a cross-sectional view of a valve pin coupling having a cartridge heater according to another embodiment of the present invention;

FIG. 4 is a cross-sectional view of a valve pin coupling having a pin holder with a narrowed neck portion according to another embodiment of the present invention;

FIG. 5 is a cross-sectional view of a valve pin coupling employing an adhesive according to another embodiment of the present invention;

FIG. 6 is a cross-sectional view of a valve pin coupling holding a valve pin having a narrowed neck portion according to another embodiment of the present invention;

FIG. 7 is a cross-sectional view of a valve pin coupling having a screw-connected flange according to another embodiment of the present invention; and

FIG. 8 is a cross-sectional view of a valve pin having a narrowed neck portion connected directly to a valve pin plate according to another embodiment of the present invention.

### DETAILED DESCRIPTION OF THE INVENTION

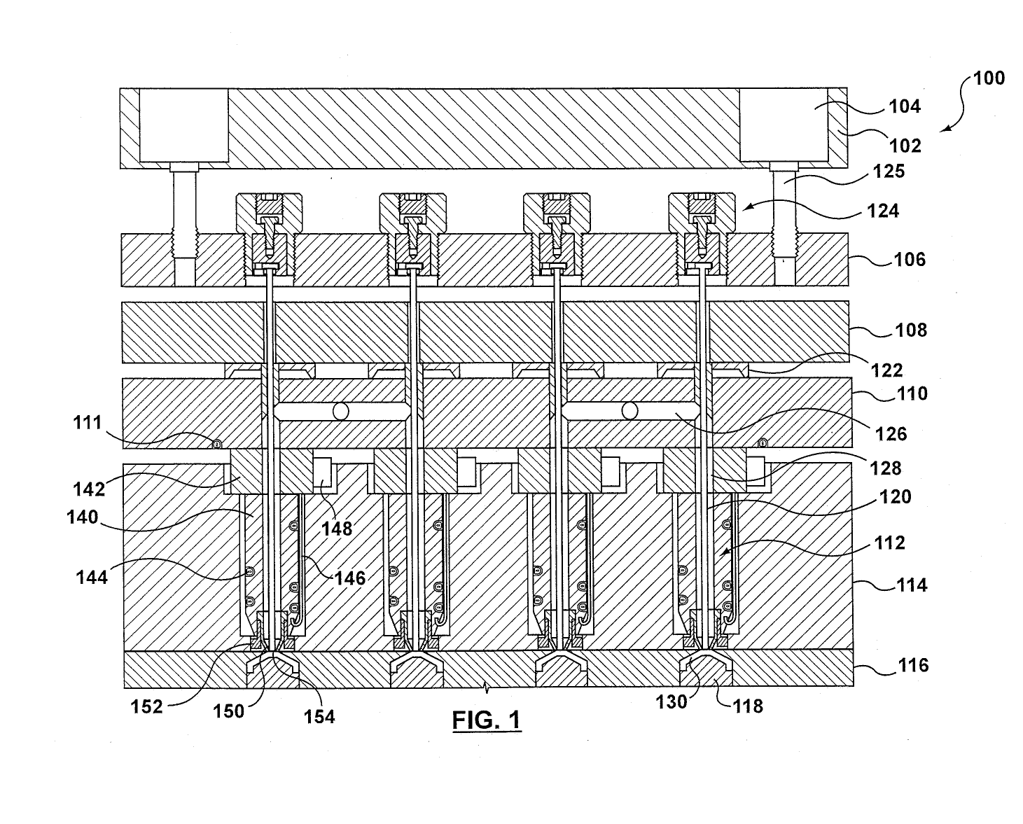

FIG. 1 shows an injection molding apparatus 100 according to an embodiment of the present invention. The features and aspects described for the other embodiments can be used accordingly with the present embodiment.

The injection molding apparatus includes an actuator plate 102, actuators 104, a valve pin plate 106, a back plate 108, a manifold 110, at least one nozzle 112, a mold plate 114, a cavity plate 116, cores 118, valve pins 120, valve pin bushings 122, and valve pin couplings 124. The injection molding apparatus 100 can include any number of manifolds and nozzles, in any configuration. In this embodiment, one manifold is shown for simplicity. The injection molding apparatus 100 can include additional components, such as inlet components, mold plates, alignment dowels, mold gate inserts, and cooling channels, among others.

The actuator plate 102 has openings for accommodating the actuators 104. If the actuators 104 depend on a working fluid for operation (i.e., pneumatic or hydraulic types), fluid conduits can be provided in the actuator plate 102. Should the actuators 104 be electric or magnetic or of some other design, electrical conduits can be provided.

The actuators 104 are disposed in the actuator plate 102 and can be pneumatic, hydraulic, electric, magnetic, or of some other design. The actuators 104 can translate the valve pin plate 106 by linear motion (e.g., a pneumatic piston) or rotary motion (e.g., an electric screw drive). To accomplish this, each actuator 104 has a stationary part (e.g., a housing or cylinder) connected to the actuator plate 102 and has a movable part 125 (e.g., a piston) connected to the valve pin plate 106. The number of actuators is a design choice, and in other embodiments more or fewer actuators can be used. Any style of actuator is suitable, provided that it can move the valve pin plate 106.

The valve pin plate 106 is connected to the movable part 125 of each actuator 104. In the embodiment of FIG. 1, valve pin plate 106 includes a plurality of threaded openings for receiving corresponding threads on valve pin couplings 124. In another embodiment, valve pin couplings 124 may be secured within valve pin plate in another manner. The valve pin plate 106 can move up and down in response to the actuation of the actuators 104. The valve pin plate 106 need not be a plate as such, but can be any rigid member capable of connecting one or more actuators to a plurality of valve pin couplings. In other embodiments, the valve pin plate 106 is an assembly of stacked plates.

The back plate 108 is disposed between the valve pin plate 106 and the valve pin bushings 122 and serves to secure cylindrical bushing portions of the valve pin bushings 122 within corresponding bores in the manifold 110. The back plate 108 has several bores through which the valve pins 120 extend.

The manifold 110 defines a manifold channel 126, or network of channels, for delivering molding material (e.g., plastic melt) and includes a manifold heater 111. The manifold channel 126 receives molding material from an inlet component (not shown) or an upstream manifold (not shown). The manifold heater 111 can be of any design, such as the insulated resistance wire illustrated. It should also be mentioned that, because of the plate interconnections (not shown), the manifold 110 is stationary relative to the stationary parts of the actuators 104.

The nozzles 112 are connected to the manifold 110 (e.g., by bolts, not shown) and each nozzle 112 defines one of a plurality of nozzle channels 128 in communication with the manifold channel 126. In this embodiment, each nozzle 112 includes a nozzle body 140, a nozzle head and/or flange 142, a nozzle heater 144 embedded in the nozzle body 140, a thermocouple 146, a terminal end 148 for connecting the nozzle heater 144 to a power source (not shown), a nozzle tip 150, and a tip retainer 152. If one or more of the manifold 110 and nozzles 112 are heated, together they define a hot runner for processing thermoplastics or similar heat-requiring materials. If heaters are omitted from the manifold 110 and nozzles 112, the injection molding apparatus 100 can be used to process thermosets or similar materials requiring heaterless processing. In another embodiment, the plurality of nozzle channels 128 is defined by a common nozzle body (not shown). It would be understood by one of skill in the art that any hot runner valve-gated nozzle may be adapted for use in embodiments hereof without departing from the scope of the present invention.

The mold plate 114 has wells to accommodate and support the nozzles 112. The wells are sized to thermally insulate the nozzles 112 from the surrounding material. The cavity plate 116 and the cores 118 define cavities 130, and the cavity plate 116 defines mold gates 154 leading to the cavities 130. Each mold gate 154 is associated with a nozzle channel 128. The cores 118 are separable from the cavity plate 116 to allow ejection of molded products from the cavities 130. In other embodiments, a single cavity can be fed molding material by several nozzles 112.

Each of the valve pins 120 extends from one of the valve pin couplings 124 through one of the nozzles 112 and nozzle tips 150 to seat within the associated mold gate 154 for controlling the flow of molding material into the cavity 130.

Each valve pin bushing 122 is held to the manifold 110 by the back plate 108. Each valve pin bushing 122 includes a disc-shaped main body and a cylindrical bushing portion connected to and extending from the main body and into the manifold 110. Each valve pin bushing 122 has a valve pin bore sized to seal against the valve pin 120 while still allowing the valve pin 120 to slide therein.

Each valve pin coupling 124 couples a respective valve pin 120 to the valve pin plate 106. Each valve pin coupling 124 transmits actuator closing force to the respective valve pin 120 when the valve pins 120 are being closed, i.e., seated within mold gates 154. Each valve pin coupling 124 also transmits an opening force to move the respective valve pin 120 when the valve pins 120 are being opened, i.e., unseated from mold gates 154. During normal operation, the opening force is relatively small. However if one of the valve pins becomes immobilized or stuck, the required opening force becomes larger.

When a valve pin 120 becomes immobilized, a breakable mechanical connection in or near the valve pin coupling 124 is broken by an operator or due to the cause of the immobilization to allow the other valve pins 120 to continue to operate normally. In this embodiment, the injection molding apparatus 100 includes a plurality of breakable or destroyable mechanical connections, one for each valve pin 120. Each breakable mechanical connection connects one of the valve pins 120 to the valve pin plate 106, allowing the valve pin plate 106 to move the valve pin 120 between opened and closed positions of the associated mold gate 154. After being destroyed by an operator or due to the cause of the immobilization, the breakable mechanical connection no longer connects the valve pin 120 to the valve pin plate 106, thereby preventing the valve pin plate 106 from moving the respective valve pin 120. Various valve pin couplings 124 and their breakable mechanical connections are described in more detail below.

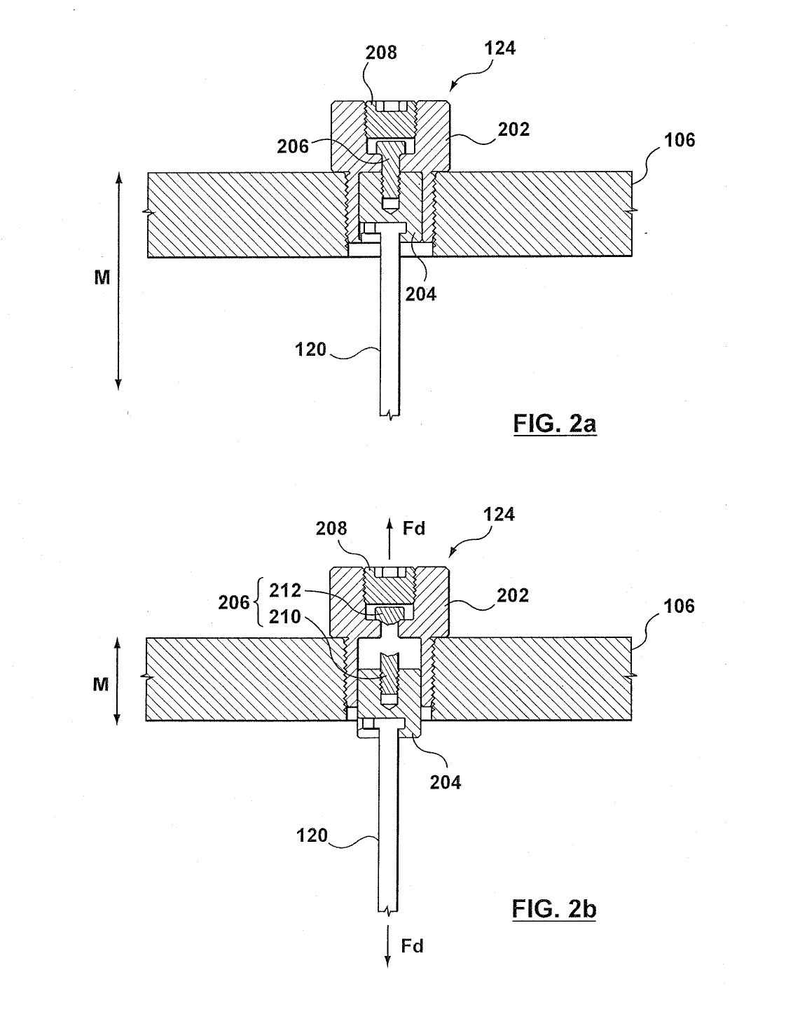

FIG. 2A shows a close-up view of the valve pin coupling 124. The valve pin coupling 124 includes a main body 202, a pin holder 204, a screw 206 connecting the main body 202 and the pin holder 204, and a cap piece 208. When the valve pin plate 106 moves back and forth (up and down, with respect to the page), as indicated by M, the valve pin 120 moves as well. It should be noted in the subsequent description of the operation of valve pin plate 106 that the use of “up” and “down” or “upward” and “downward” is in reference to the position of the valve pin plate and other components as shown in the figures and may or may not correspond to the direction of movement of such a valve pin plate and other components installed in an injection molding machine.

The main body 202 has a thread on an outside surface that is threaded into a threaded bore of the valve pin plate 106. This allows the valve pin coupling 124 to be removable from the valve pin plate 106.

The pin holder 204 fits into a downward-facing opening of the main body 202 and abuts the main body 202 inside this opening. The pin holder 204 has a slot sized to receive the head portion of the valve pin 120. This allows the valve pin 120 to move back and forth with the pin holder 204. For instance, when the valve pin plate 106 moves down, the valve pin 120 is moved down by the abutment of the pin holder 204 against the main body 202.

The screw 206 holds the pin holder 204 to the main body 202. The screw 206 can have a head shaped to receive a tool (e.g., hex wrench, socket driver, screw driver) for connection to the main body 202 and pin holder 204, when the protective cap piece 208 is removed to allow access. The screw 206 is made of a material substantially weaker than the surrounding connected parts. In this embodiment the screw 206 is made of plastic, such as nylon, while the other components are made of metal, such as steel. In other embodiments, the screw 206 can be made of different kinds of plastics, ceramics, or other materials having a lower tensile strength than a material of the surrounding components, such as pin holder 204, main body 202, valve pin 120, and valve pin plate 106, which are made of a material or materials having a higher tensile strength such as a metal. The screw 206 threads into a threaded bore of the pin holder 204. The head of the screw 206 straddles an unthreaded bore of the main body 202. As such, the pin holder 204, and thus the valve pin 120, is pulled upwards by a tensile force on the screw 206 caused by the upward movement of the valve pin plate 106. When the valve pin plate 106 is moved downward, the main body 202 directly pushes on the pin holder 204 and the screw 206 is not required to undergo any significant stress. The screw 206 is a breakable mechanical connection that can be configured to break at a desired load by customizing the size, geometry, thread shape, and/or material.

FIG. 2B shows the screw 206 broken under a breaking load, Fd, created by the valve pin 120 being held stationary, i.e., being held by frozen molding material in a nozzle whose heater is broken or has been turned off by an operator, and the valve pin plate 106 being actuated upwards. The breaking load, Fd, is larger than the normal load exerted on the pin when the pin 120 is moved up during normal operation by the valve pin plate 106. The screw 206 is the weakest component, and thus snaps before failure of any of the other components. After the screw 206 is broken, the valve pin plate 106 can continue to be actuated to move the other valve pins in the system in a regular fashion to open and close the respective mold gates. Thus, nozzle 112 is taken out of service when the valve pin 120 is held in a downward position, e.g., due to melt freezing or hardening in the nozzle, such as when a nozzle heater fails or is shut-off, or by applying a mechanical stopping means, and the valve pin plate 106 is moved up such that screw 206 is snapped under a breaking load, which frees valve pin 120 from valve pin plate 106 and allows continued operation of the other nozzles.

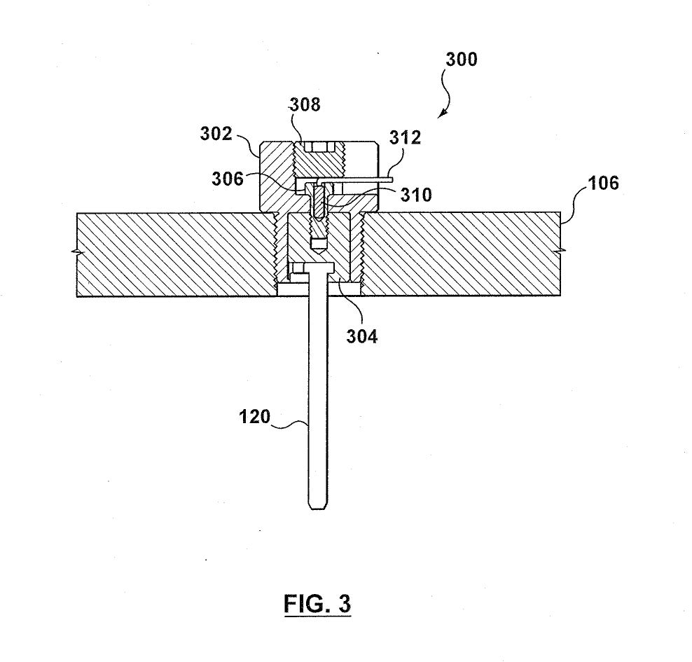

FIG. 3 shows a valve pin coupling 300 according to another embodiment of the present invention. The features and aspects described for the other embodiments can be used accordingly with the present embodiment. Only differing features and aspects of the present embodiment are described in detail.

The valve pin coupling 300 includes a main body 302, a pin holder 304, a screw 306 connecting the main body 302 and the pin holder 304, a cap piece 308, and a cartridge heater 310. The cartridge heater 310 is disposed near the screw 306 or, as in this case, inside the screw 306. The cartridge heater 310 can be an insulated wire element heater similar to those conventionally used on nozzles and manifolds. Wires 312 connect the cartridge heater 310 to a switchable power supply. The screw 306 connects the valve pin holder 304 to the main body 302. The screw 306 is a meltable element made of a meltable material, such as plastic. In other embodiments, meltable elements of other shapes or configurations can be used (e.g., bolts, rods, plugs). When the valve pin holder 304 is to be disconnected from the main body, power is applied to the wires 312 thereby energizing the cartridge heater 310 and melting the screw 306. The screw 306 is thus thermally separated into an upper piece that remains with the main body 302 and a lower piece 304 that remains in the pin holder 304. In this way, the screw 306 is a breakable mechanical connection. The cartridge heater 310 can be designed to fail during use, i.e., to break the circuit, much like a fuse, and in this case would be part of the breakable mechanical connection. Thus, when the nozzle 112 is to be taken out of service, an operator need only supply temporary power to the wires 312.

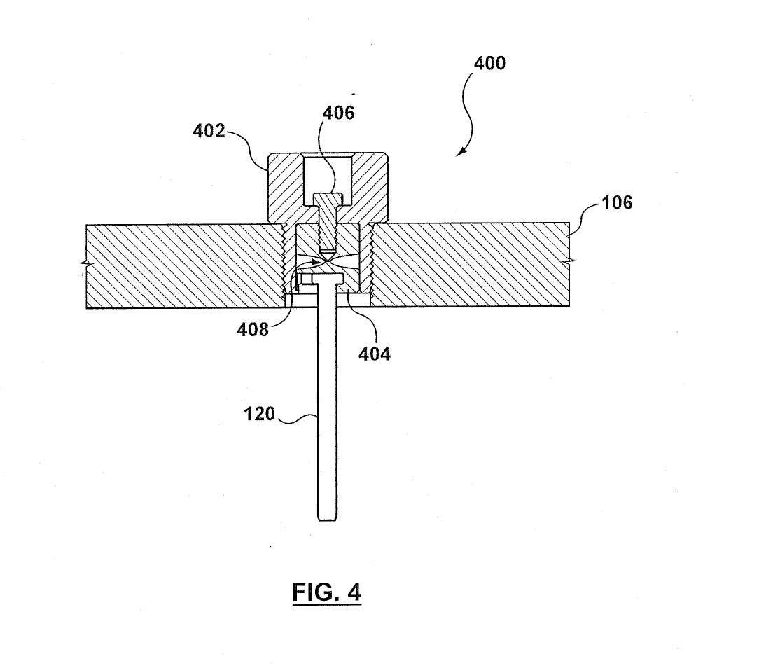

FIG. 4 shows a valve pin coupling 400 according to another embodiment of the present invention. The features and aspects described for the other embodiments can be used accordingly with the present embodiment. Only differing features and aspects of the present embodiment are described in detail.

The valve pin coupling 400 includes a main body 402, a pin holder 404, and a screw 406 connecting the main body 402 and the pin holder 404. The pin holder 404 has an area of weakness that in this embodiment is a narrowed or thinned neck portion 408. The pin holder 404 or at least the neck portion 408 thereof can be made of a material having a lower tensile strength than the surrounding parts to which it directly or indirectly attaches. In this embodiment the entire pin holder 404 is made of a plastic material, such as nylon, having a lower tensile strength than the other components that are made of a metal, such as steel, having a higher tensile strength. In other embodiments, different kinds of plastics, ceramics, metals, can be used for the entire pin holder 404 or just the narrowed neck portion 408 thereof. The material and cross-sectional area of neck portion 408 can be configured to fail at the desired breaking load. For the same breaking load, if a stronger material, such as steel, is used, then neck portion 408 should have a cross-sectional area smaller than if a weaker material, such as a plastic, is used. The pin holder 404 is thus a breakable mechanical connection that can be broken when subject to a breaking load.

Nozzle 112 is taken out of service when valve pin 120 is held stationary in a downward position, e.g., due to melt freezing or hardening in the nozzle, such as when a nozzle heater fails or is shut-off, or by applying a mechanical stopping means, and valve pin plate 106 moves upward thereby breaking pin holder 404 at the narrowed neck portion 408 under a breaking load, which frees valve pin 120 from valve pin plate 106 and allows continued operation of the other nozzles.

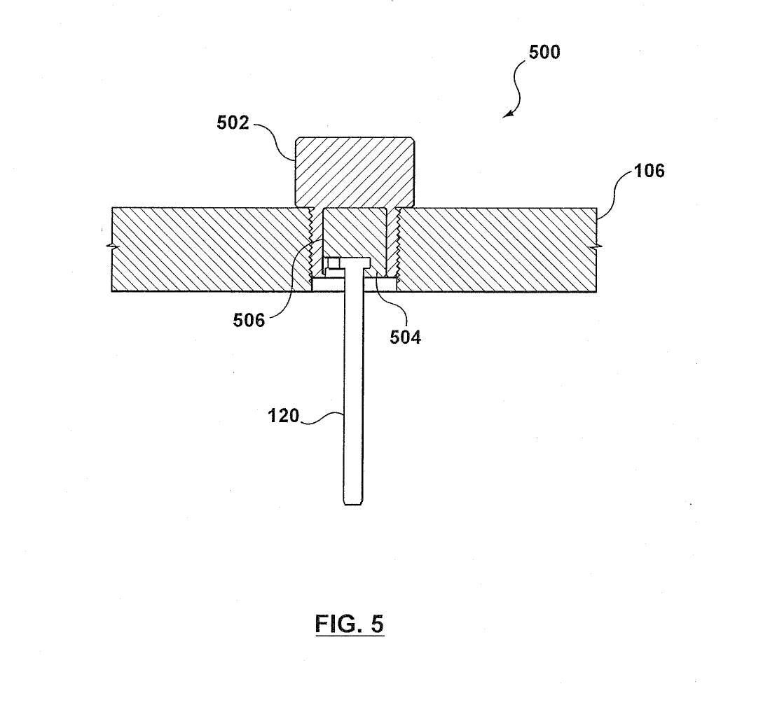

FIG. 5 shows a valve pin coupling 500 according to another embodiment of the present invention. The features and aspects described for the other embodiments can be used accordingly with the present embodiment. Only differing features and aspects of the present embodiment are described in detail.

The valve pin coupling 500 includes a main body 502, a pin holder 504, and an adhesive layer 506 connecting the main body 502 and the pin holder 504. The adhesive layer 506 is a breakable mechanical connection that can be broken when subject to a breaking load. Adhesives suitable for use in embodiments hereof include but are not limited to Loctite® 641 an anaerobic controlled strength retaining compound available from Henkel AG & Co. KGaA of Germany, VHB™ Tape a double-sided acrylic foam tape available from 3M Corporation of St. Paul, Minn., Tru-Bond® 18400 UV Series PSA a UV curable pressure sensitive adhesive that resists vibration and temperatures of 200 c available from ITW Devcon of the United Kingdom, RTV 382 a high temperature adhesive and sealant for use on vibration prone machines available from Intek Adhesives Ltd. of the United Kingdom, and Permabond ET 510 a fast curing 2 part epoxy available from Permabond Engineering Adhesives of the United Kingdom.

The type of adhesive used, the amount of adhesive used, the materials of the main body 502 and the pin holder 504, and the shape and size of the adhesive layer 506 can each play a part in determining the breaking load of the adhesive layer. The adhesive layer 506 can be configured to fail at a particular breaking load. Nozzle 112 is taken out of service when valve pin 120 is held in a downward position, e.g., due to melt freezing or hardening in the nozzle, such as when a nozzle heater fails or is shut-off, or by applying a mechanical stopping means, and valve pin plate 106 is moved upward, which due to the breaking load created forcibly separates the connection established by adhesive layer 506 and thereby frees valve pin 120 from valve pin plate 106 and allows continued operation of the other nozzles.

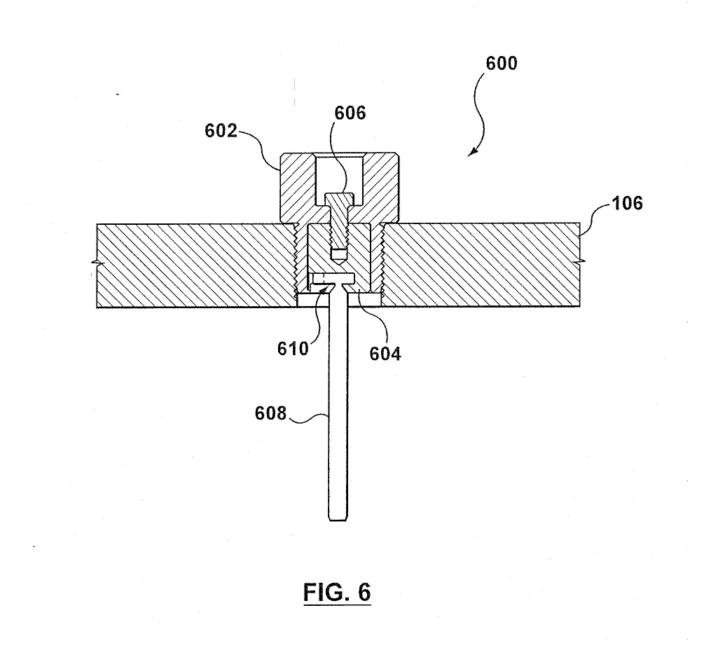

FIG. 6 shows a valve pin coupling 600 according to another embodiment of the present invention. The features and aspects described for the other embodiments can be used accordingly with the present embodiment. Only differing features and aspects of the present embodiment are described in detail.

The valve pin coupling 600 includes a main body 602, a pin holder 604, and a screw 606 connecting the main body 602 and the pin holder 604. The pin holder 604 holds a valve pin 608.

The valve pin 608 has a thinned or necked portion 610, which can be located, for example, adjacent its head. The thinned portion 610 connects the remainder of the valve pin 608 to the valve pin plate 106. Thinned portion 610 and valve pin 608 are unitary and of the same material. Alternatively, thinned portion 610 can be made of a material substantially weaker than the rest of the valve pin. In other embodiments, different kinds of plastics, ceramics, metals, can be used for thinned portion 610. The material and cross-sectional area of thinned portion 610 can be configured to fail at the desired breaking load. For the same breaking load, if a stronger material, such as steel, is used, then thinned portion 610 should have a cross-sectional area smaller than if a weaker material, such as plastic, is used. When weaker materials are used, thinned portion 610 can be replaced by a weakened portion having the same (or even larger) diameter as the valve pin 608. The thinned/weakened portion 610 is thus a breakable mechanical connection that can be broken when subject to a breaking load.

Nozzle 112 is taken out of service when valve pin 608 is held stationary by, for e.g., hardened melt or a mechanical stopping means, and valve pin plate 106 is moved upward or in a direction away from fixed valve pin 608 such that thinned/weakened portion 610 of valve pin 608 breaks under a breaking load, thereby freeing valve pin 608 from valve pin plate 106 and allowing continued operation of the other nozzles.

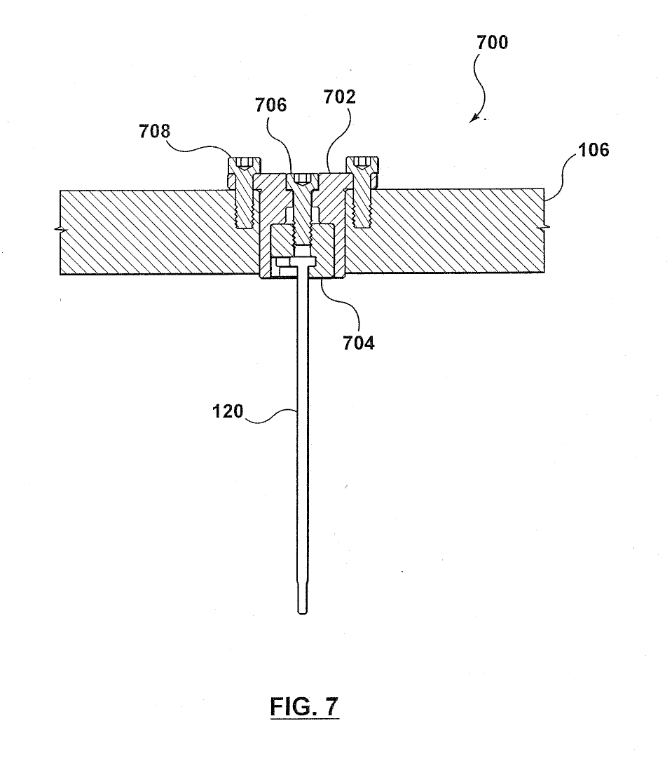

FIG. 7 shows a valve pin coupling 700 according to another embodiment of the present invention. The features and aspects described for the other embodiments can be used accordingly with the present embodiment. Only differing features and aspects of the present embodiment are described in detail.

The valve pin coupling 700 includes a main body 702, a pin holder 704, a screw 706 connecting the main body 702 and the pin holder 704, and screws 708 fixing the main body 702 to the valve pin plate 106. The screw 708 is made of a material having a lower tensile strength than the other components of valve pin coupling 700, valve pin 120, and valve pin plate 106 and thus forms a breakable mechanical connection.

Valve pin coupling 700 is similar to that of FIGS. 2A-2B. One difference is that the main body 702 is not threaded to the valve pin plate 106, and instead has a flange that allows it to be removably fastened to the valve pin plate 106 by the screws 708. Another difference is that the valve pin coupling 700 does not have a cap piece located above the head of the screw 706. Instead, the head of the screw 706 is flush with the top surface of the main body 702. During operation the screw 706 can be snapped or broken as in the other embodiments.

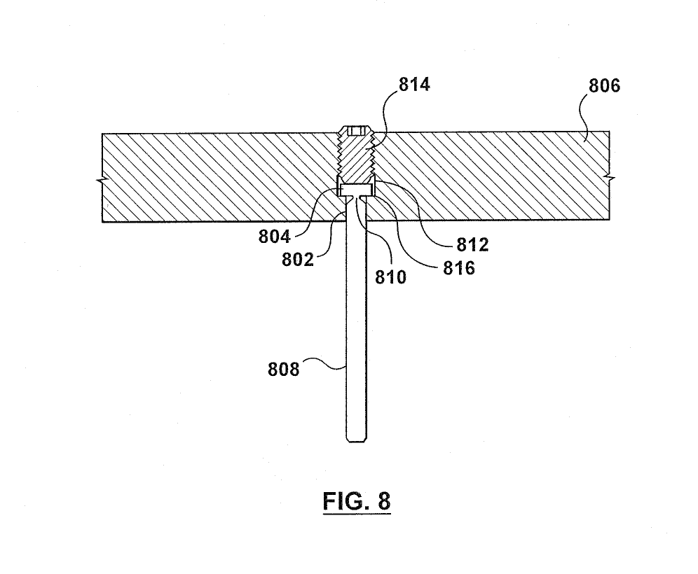

FIG. 8 shows a valve pin 808 and valve pin plate 806 according to another embodiment of the present invention. The features and aspects described for the other embodiments can be used accordingly with the present embodiment. Only differing features and aspects of the present embodiment are described in detail.

Valve pin 808 extends through a first bore 802 in the valve pin plate 806. The head 804 of the valve pin 808 sits in a second bore 812 of valve pin plate 806, which is wider than first bore 802, and rests on a shoulder 816 where second bore 812 transitions to first bore 802. A fastener 814, such as the hex-socket screw depicted, is threaded into second bore 812 and may be held against loosening by a lock nut (not shown) or other means. Screw 814 contacts the top of valve pin head 804 and thus secures the valve pin 808 in position. As such, screw 814 or other fastener in combination with the shoulder 816 can be considered a valve pin coupling. Valve pin 808 can be removed by removing the screw 814. In another, similar embodiment, the head 804 of the valve pin 808 is sandwiched between two plates that are bolted together.

Valve pin 808 has a thinned or otherwise weakened portion 810, which can be located, for example, adjacent its head 804. Thinned portion 810 connects the remainder of valve pin 808 to valve pin plate 806. Thinned portion 810 and valve pin 808 are unitary and of the same material. Alternatively, thinned portion 810 can be made of a material substantially weaker than the rest of the valve pin. In other embodiments, different kinds of plastics, ceramics, metals, can be used for thinned portion 810. The material and cross-sectional area of thinned portion 810 can be configured to fail at the desired breaking load, as discussed above with reference to the embodiment of FIG. 6. The thinned or weakened portion 810 is thus a breakable or destroyable mechanical connection that can be broken when subject to a breaking load.

Nozzle 112 is taken out of service when valve pin 808 is held stationary by, for e.g., hardened melt or a mechanical stopping means, and valve pin plate 806 is moved upward or in a direction away from fixed valve pin 808 such that thinned/weakened portion 810 of valve pin 808 breaks under a breaking load, thereby freeing valve pin 808 from valve pin plate 806 and allowing continued operation of the other nozzles.

Although many embodiments of the present invention have been described, those of skill in the art will appreciate that other variations and modifications may be made without departing from the spirit and scope thereof as defined by the appended claims.

What is claimed is:

1. An injection molding apparatus, comprising:
an actuator;
a valve pin plate connected to and translatable by the actuator;
a plurality of valve pins, each valve pin associated with a mold gate of a mold cavity; and
a plurality of breakable mechanical connections, each breakable mechanical connection securing a respective valve pin to the valve pin plate such that the valve pin plate simultaneously moves the valve pins between a closed position in which the valve pins are seated in their respective mold gates and an open position in which the valve pins are unseated from their respective mold gates,
wherein each breakable mechanical connection is capable of being independently broken to detach the respective valve pin from the valve pin plate thereby preventing the valve pin plate from moving the respective valve pin.

2. The injection molding apparatus of claim 1, wherein each breakable mechanical connection is formed of a material that has a lower tensile strength than a material of the valve pin.

3. The injection molding apparatus of claim 2, wherein each breakable mechanical connection comprises a breakable screw.

4. The injection molding apparatus of claim 3, further comprising:
a plurality of valve pin couplings for attaching the plurality of valve pins to the valve pin plate,
wherein each valve pin coupling includes a body portion that is connected to the valve pin plate and a valve pin holder that holds a respective valve pin and wherein a respective breakable screw connects the body portion to the valve pin holder.

5. The injection molding apparatus of claim 1, wherein each breakable mechanical connection comprises a heater and a meltable element, the heater disposed near or inside the meltable element, wherein when the heater is energized the meltable element melts to detach the respective valve pin from the valve pin plate.

6. The injection molding apparatus of claim 1, wherein each breakable mechanical connection comprises a valve pin holder that couples a respective valve pin to the valve pin plate.

7. The injection molding apparatus of claim 6, wherein the valve pin holder includes a neck portion upstream of a head of the valve pin that is breakable to detach the respective valve pin from the valve pin plate.

8. The injection molding apparatus of claim 1, wherein each breakable mechanical connection comprises an adhesive.

9. The injection molding apparatus of claim 8, further comprising:
a plurality of valve pin couplings for attaching the plurality of valve pins to the valve pin plate,
wherein each valve pin coupling includes a body portion that is connected to the valve pin plate and a valve pin holder that holds a respective valve pin and wherein the adhesive connects the body portion to the valve pin holder.

10. The injection molding apparatus of claim 1, wherein each breakable mechanical connection comprises a weakened portion of the respective valve pin.

11. The injection molding apparatus of claim 10, wherein the weakened portion of the valve pin comprises a thinned section of the valve pin that is proximate an upstream end of the valve pin.

12. The injection molding apparatus of claim 1, wherein each breakable mechanical connection is configured to fail at a breaking load that is larger than a normal load exerted on the valve pin by the valve pin plate as operated by the actuator.

13. The injection molding apparatus of claim 1 further comprising:
a nozzle including a nozzle heater and defining a nozzle melt channel for directing a melt stream of moldable material through one of the mold gates into the respective mold cavity, the nozzle melt channel having the valve pin associated with the mold gate extending there through.

14. The injection molding apparatus of claim 13, wherein the melt stream hardens in the nozzle melt channel when the nozzle heater is turned off and thereby grips the valve pin extending there through to prevent the valve pin from moving with the valve pin plate.

15. A method of operating an injection molding apparatus, comprising:
providing a plurality of breakable mechanical connections connecting valve pins to a valve pin plate, where in each valve pin is associated with a respective mold gate;
actuating the valve pin plate to move the valve pins between open positions where a melt stream of moldable material flows through the associated mold gates and closed positions where the melt stream is prevented from flowing through the associated mold gates;
breaking one of the breakable mechanical connections to disconnect one of the valve pins from the valve pin plate; and
continuing to actuate the valve pin plate to move the valve pins that remain connected to the valve pin plate.

16. The method of claim 15, wherein the step of breaking one of the breakable mechanical connections comprises holding the respective valve pin stationary, and moving the valve pin plate to break the breakable mechanical connection.

17. The method of claim 16, wherein the step of holding the respective valve pin stationary includes turning off a heater of a nozzle having a nozzle melt channel through which the valve pin extends and allowing the melt stream to harden in the nozzle melt channel around the valve pin and thereby hold the valve pin stationary.

18. The method of claim 17, wherein the step of breaking one of the breakable mechanical connections comprises energizing a heater to melt the breakable connection.
